(19) United States
(12) Patent Application Publication
(10) Pub. No.: US 2011/0195664 A1
(43) Pub. Date: Aug. 11, 2011

(54) WIRELESS CONTROL SYSTEM FOR A SPA

(75) Inventors: James KEIRSTEAD, Leduc (CA); Dave ANDERSEN, Thorsby (CA); Grant SERINK, Edmonton (CA); Stuart OLSEN, Edmonton (CA)

(73) Assignee: Global Spa Components Inc., a division of Blue Falls Manufacturing Ltd., Thorsby (CA)

(21) Appl. No.: 13/022,547

(22) Filed: Feb. 7, 2011

Related U.S. Application Data
(60) Provisional application No. 61/301,841, filed on Feb. 5, 2010.

(51) Int. Cl. H04B 7/00

(52) U.S. Cl. 455/41.2

(57) ABSTRACT

A wireless control system is provided for remotely controlling various modules of a spa. The control system comprises a wireless interface for receiving a combination of communication signals containing control data and BLUETOOTH signals from a remote wireless device. The communication signals contain at least control data for controlling the various modules of the spa and the BLUETOOTH signals contain media data such as streaming audio data. The communication signals can be transmitted using Wi-Fi, GSM or CDMA protocols. The control system further comprises a wired interface connected to the various modules of the spa and in communication with the wireless interface. The wired interface controls the various modules of the spa in response to the control data.

### CROSS REFERENCE TO RELATED APPLICATIONS

This application claims the benefits under 35 U.S.C 119(e) of U.S. Provisional Application Ser. No. 61/301,841, filed Feb. 5, 2010, which is incorporated fully herein by reference.

### FIELD OF INVENTION

The invention relates to a wireless control system for controlling various modules of a spa. More particularly, the control system is configured to receive a communication signal containing control data for controlling the various modules of the spa such as a pump, heater, lighting or an entertainment system and Bluetooth™ signals from a remote wireless device, the BLUETOOTH signals for streaming multimedia content to the entertainment system. Further, the system can interact with remote and/or local servers for communication with the remote wireless device regarding performance parameters of the spa modules.

### BACKGROUND OF INVENTION

Spas implement local controls and electrical components including operation of water pumps, air pumps, heaters, lighting and some media components.

Current spa controllers are built upon dedicated closed architecture, designed for defined, finite applications, with low to mid performance microcomputer circuits offering a membrane keypad and an often times cryptic numeric display user interface. These low cost, low functionality electronics tend to use simple Liquid Crystal Display (LCD) displays and dome type keypads. The typical circuit permits a user to turn on the various pumps, set temperature and access simple options such as Light Emitting Diode (LED) lighting systems. Prominent suppliers of such spa controllers in North America include Gecko Alliance (Quebec, Canada) and Balboa Water Group (California, USA).

The currently available spa controllers are primarily dedicated to spa temperature and pump control as they do not have the performance nor multi-tasking capability to provide the users with multiple and concurrent applications. Should a change be required to the spa algorithm, a trained and skilled technician needs to exchange the controller or re-program the system via dedicated tools onsite. Typical controllers communicate problems by sounding a local audio alarm or display a cryptic numeric fault code. It is known to use infra-red remotes to adjust some controls, but merely act as a “slider” switch and are not amenable to providing more comprehensive control.

What is needed in the spa and hot tub industry is the ability to interact more meaningfully and effectively with a spa, including communicating status and set point parameters to the spa, annunciating fault conditions or establishing operating status of the spa, all of which even be conducted remotely.

### SUMMARY OF THE INVENTION

Embodiments described herein are directed to a wireless control system incorporating electronic micro-control circuits and wireless technologies that allows a user to communicate with the spa remotely through a remote wireless device for controlling various modules of the spa.

Accordingly in one broad aspect a wireless control system is provided for controlling various modules of a spa. The wireless control system comprises a wireless interface and a wired interface. The wireless interface receives a combination of communication signals and BLUETOOTH signals transmitted from a remote wireless device. The communication signals contain control data for controlling the various modules of the spa and the BLUETOOTH signals contain media data for use at the spa. The wired interface is in communication with the wireless interface and connected to the various modules of the spa, the wired interface controlling the various modules of the spa in response to the control data contained in the communication signal and communicated to the wired interface by the wireless interface.

In one embodiment, the wireless system includes a BLUETOOTH microcontroller for receiving and decoding the BLUETOOTH signals and a Wi-Fi router for receiving and decoding the communication signals, the communication signals being transmitted using Wi-Fi protocols.

In another embodiment, the wireless system implements drivers for receiving and decoding the communication signals and the BLUETOOTH signals, the drivers being embedded in an operating system such as a Windows CE™ or LINUX™ platform.

In another embodiment, the wireless control system is in communication with a remote server through a home server and an internet network.

### BRIEF DESCRIPTION OF THE DRAWINGS

FIG. 1 is a schematic block diagram of an embodiment of a wireless control system for a spa wherein control signals transmitted from a remote wireless device received by a wireless interface of the control system are decoded by drivers executed within an operating system;

FIG. 2A is a schematic block diagram of another embodiment of a wireless control system for a spa wherein the wireless interface incorporates a BLUETOOTH microcontroller and a wireless control data interface, such as a Wi-Fi router, for decoding received signals;

FIG. 2B is a schematic block diagram according to FIG. 2A further comprising a cellular modem for communication of control signals, such as when communication through the Wi-Fi router is unavailable;

FIG. 3 is a schematic diagram of the control system of FIG. 1, 2A or 2B connected to remote and/or local servers and various modules of the spa;

FIG. 4A is a schematic diagram illustrating an embodiment of a communication network formed by the control system of FIG. 1 or FIG. 2A, the remote wireless device, the remote server and the local server;

FIG. 4B is a schematic diagram illustrating an embodiment of an iPhone™ communicating with a spa through the wireless control system of FIG. 2A;

FIG. 5 is a block diagram of the BLUETOOTH microcontroller implemented in FIG. 2A;

FIG. 6 is a schematic representation of an embodiment of a circuit board assembly of a protocol converter interface between the wired interface and a local control interface for the spa according to FIG. 1 or 2A;

FIG. 7A is a schematic representation of the wired interface according to FIG. 2A illustrating an Ethernet communication with the wireless interface;

FIG. 7B is a schematic representation of the wired interface according to FIG. 1 having a Wi-Fi and BLUETOOTH wireless interface onboard and for communicating control data and media data to the processor for decoding;

FIG. 8A is a schematic representation of one embodiments of a Graphical User Interface (GUI) of the local control interface;

FIG. 8B is a schematic representation of a simple conventional membrane keypad interface of the local control interface;

FIG. 9 is a representation of an embodiment of a display of a remote wireless device in communication with the control system of a spa; and

FIGS. 10A and 10B are two examples of application status pop-ups on a remote wireless device in communication with the control system.

### DETAILED DESCRIPTION OF THE PREFERRED EMBODIMENTS

According to one embodiment, a spa is controlled by a wireless control system located at the spa. The control system is configured to receive a communication signal containing data for controlling the various modules of the spa from a remote wireless device. The communication signal can comprise Wi-Fi and cellular signals including Global System for Mobile Communications (GSM) or (Code Division Multiple Access) CDMA signals. The wireless control system can also include a Global Positioning System (GPS). The control system is also configured to receive BLUETOOTH signals from the remote wireless device, generally in proximity to the spa, such as for streaming multimedia content from the remote wireless device to the control system. The control system can also be configured to communicate with a more conventional local control interface located at the spa for controlling the various modules of the spa. The control system is also configured to interact with remote and/or local servers through wired and/or wireless internet networks.

If the control data is transmitted from the remote wireless device using Wi-Fi protocols, the control data is received and decoded by a wireless interface comprising a Wi-Fi router and configured to decode Wi-Fi control signals.

If the control data is transmitted from the remote wireless device using CDMA protocols or GSM protocols, the control data is received and decoded by a wireless interface comprising a cellular modem and configured to receive and decode GSM or CDMA protocols.

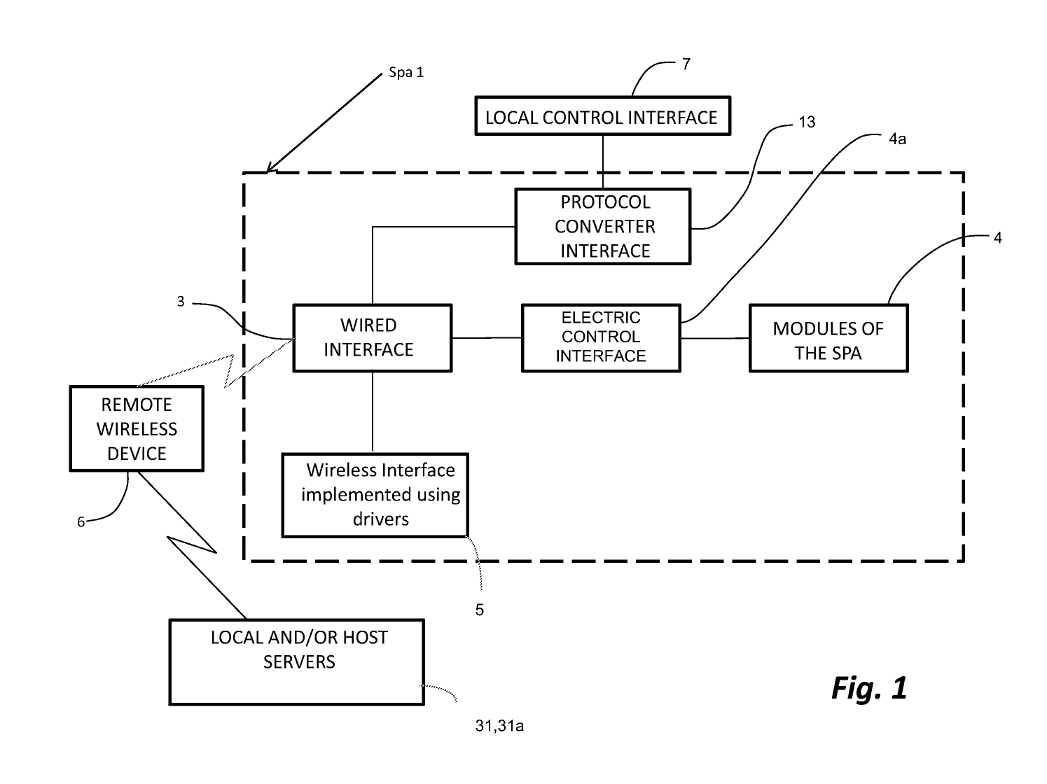

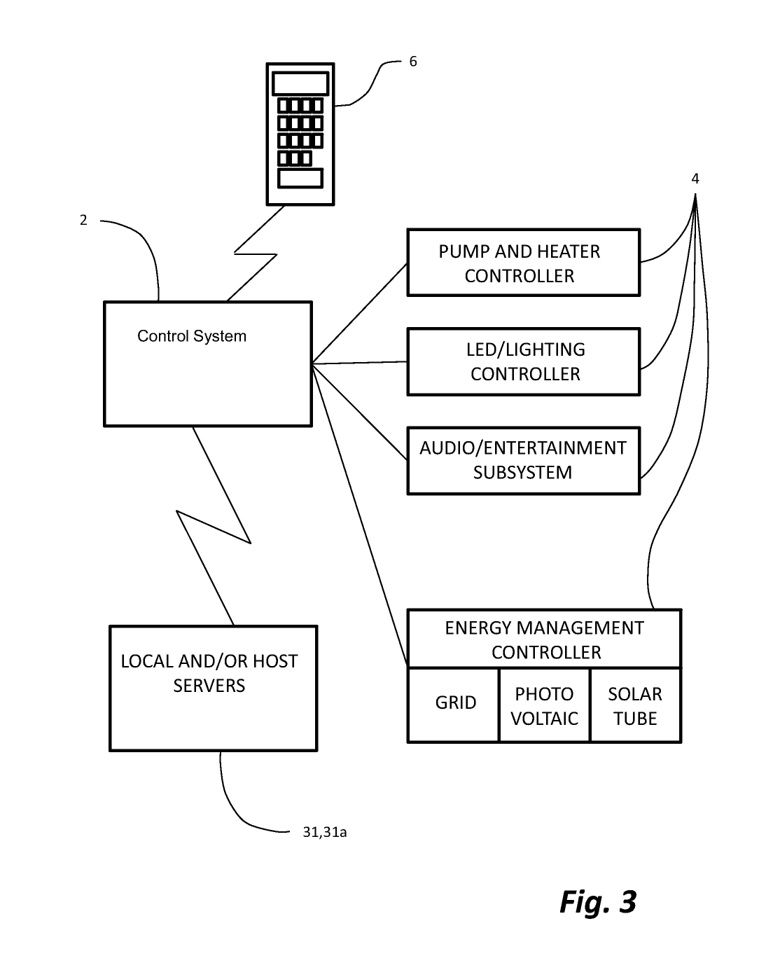

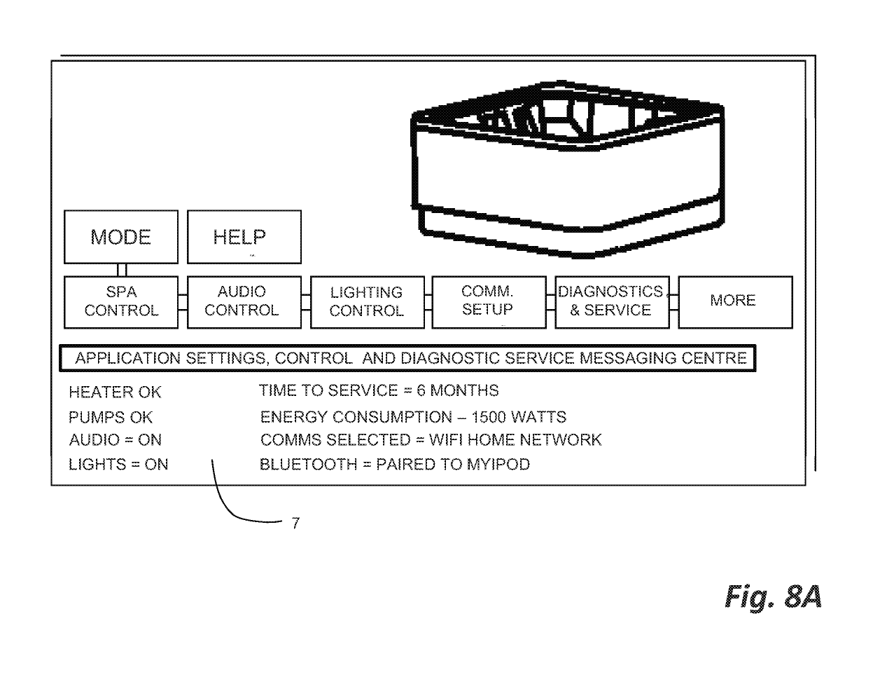

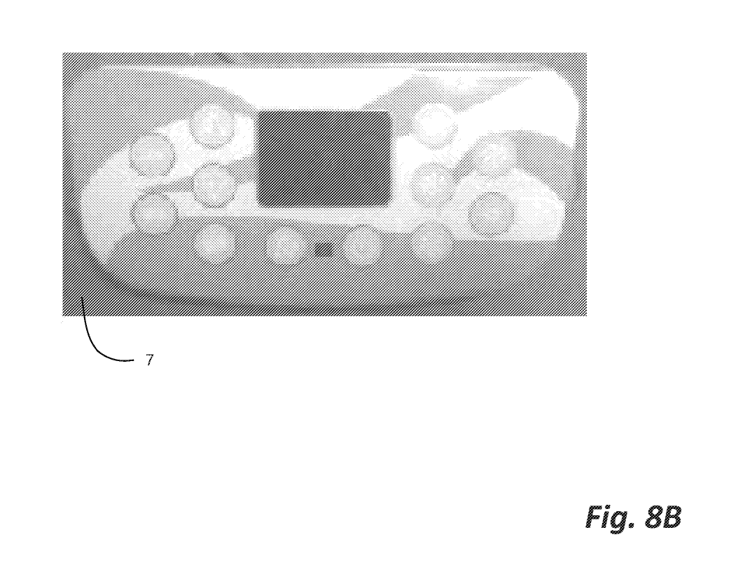

Embodiments herein are explained in the context of remote control of a spa by a remote wireless device wherein the control signals are transmitted to the spa using Wi-Fi protocols. In one embodiment, and having reference to FIGS. 1, 3 and 7B, a spa 1 is controlled by a wireless control system 2. The control system 2 comprises a wired interface 3 comprising a processor 15 for managing control signals related to parameters and operational set points of the spa 1. The wired interface 3 is connected to various modules 4 of the spa 1 through an electric interface 4a. As shown in FIG. 3, examples of various modules 4 of the spa 1 include a pump, a heater, lighting, an entertainment module and an energy management module. The electric interface 4a receives control signals from the wired interface 3 and appropriately turns modules on and off. A local control interface 7 can be provided which is coupled to the wired interface 3. The local control interface 7 is also commonly referred to as a Top Side Controller. FIGS. 8A and 8B illustrate various forms of display of such local control interfaces 7.

While a conventional top side controller or local control interface 7 can interface between the user and the wired interface 3, one embodiment of spa control comprises implementation of a wireless interface 5 for receiving a communication signals containing control data and BLUETOOTH (Trademark of Bluetooth SIG) signals transmitted from a remote wireless device 6. It is contemplated that a remote wireless device 6 such as an iPhone™ (Trademark of Apple) can send control signals, via Wi-Fi or CDMA or GSM or GPS, such as “increase spa temperature”, or “jet pump on” and also stream a playlist of audio content through BLUETOOTH. While Wi-Fi from a remote device 6 could be implemented over a wide area network, BLUETOOTH is typically only available when the remote wireless device is in close proximity with the spa 1.

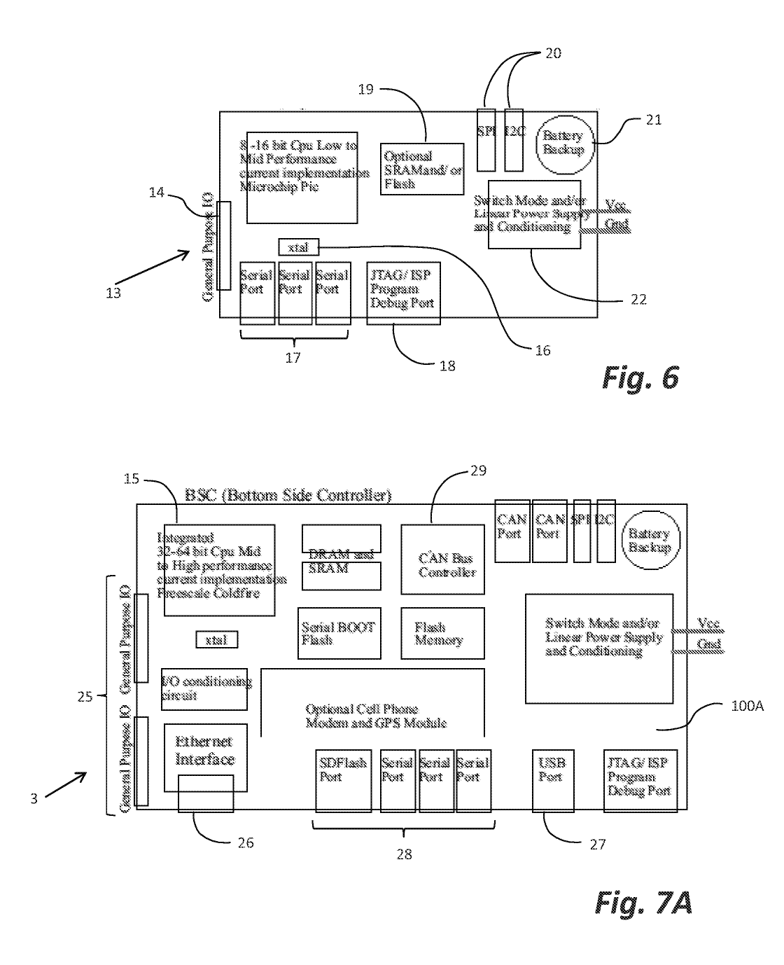

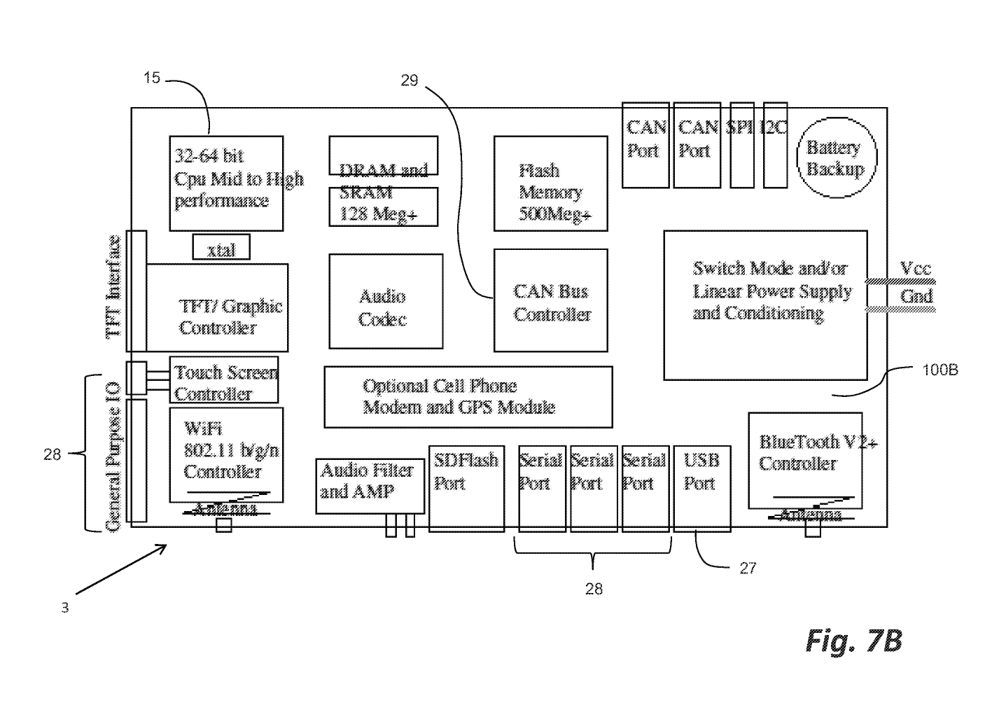

As shown in FIGS. 1 and 7B, the wireless interface 5 is in communication with the wired interface 3. Where the wireless interface 5 merely communicates raw digital data, a processor 15, such a microprocessor located at the wired interface 3 can decode the communication signals containing control data or BLUETOOTH data into control signals and audio signals suitable for module operation including an entertainment system. In one implementation, the processor 15 supports an operating system such as a Windows CE platform or environment (Trademark of Microsoft Corporation) or a Linux platform or environment (Trademark of Linux Mark Institute) and implements Wi-Fi and BLUETOOTH software or drivers for decoding the communication signals containing control data.

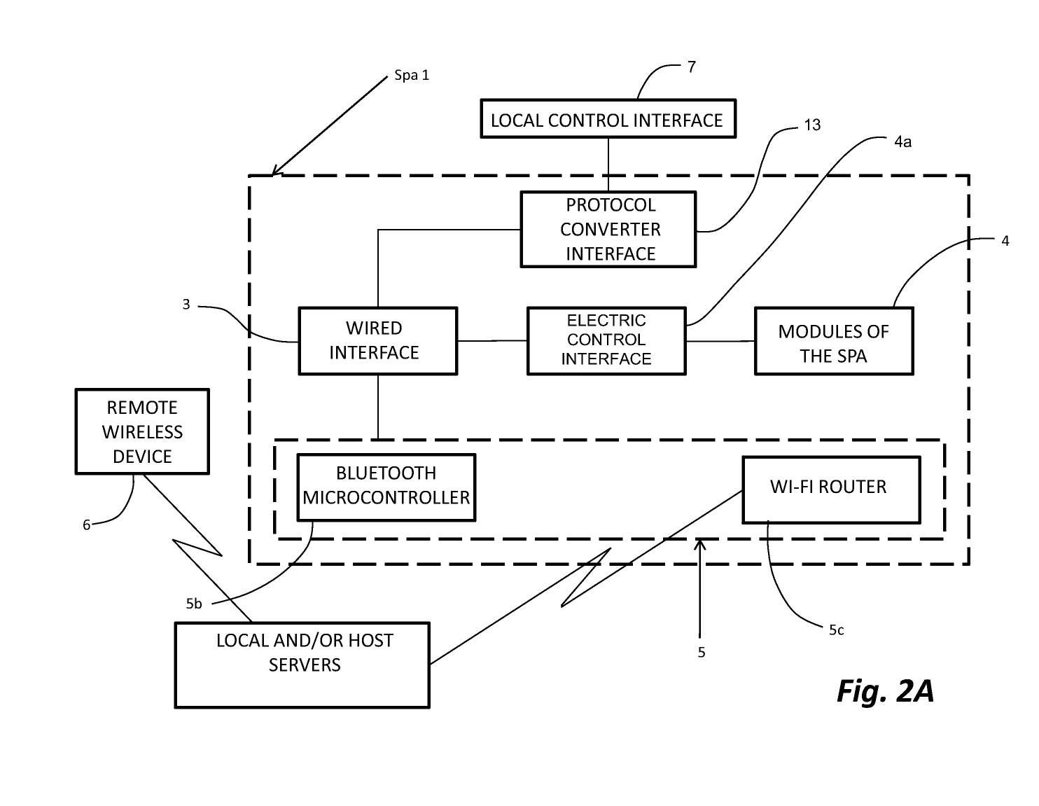

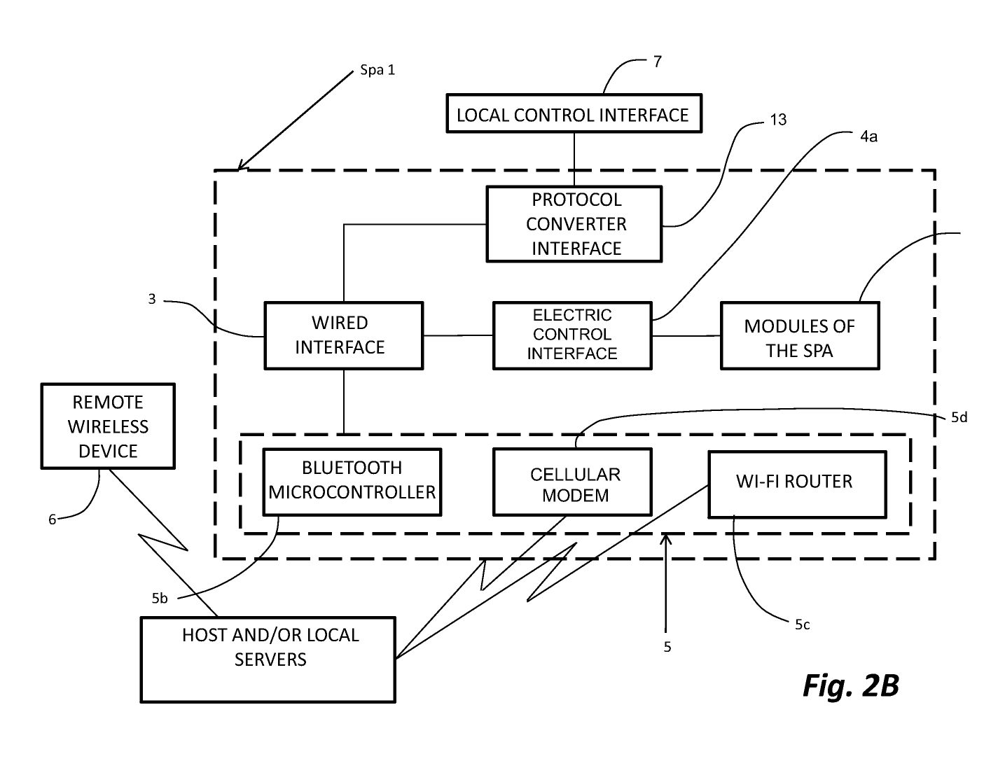

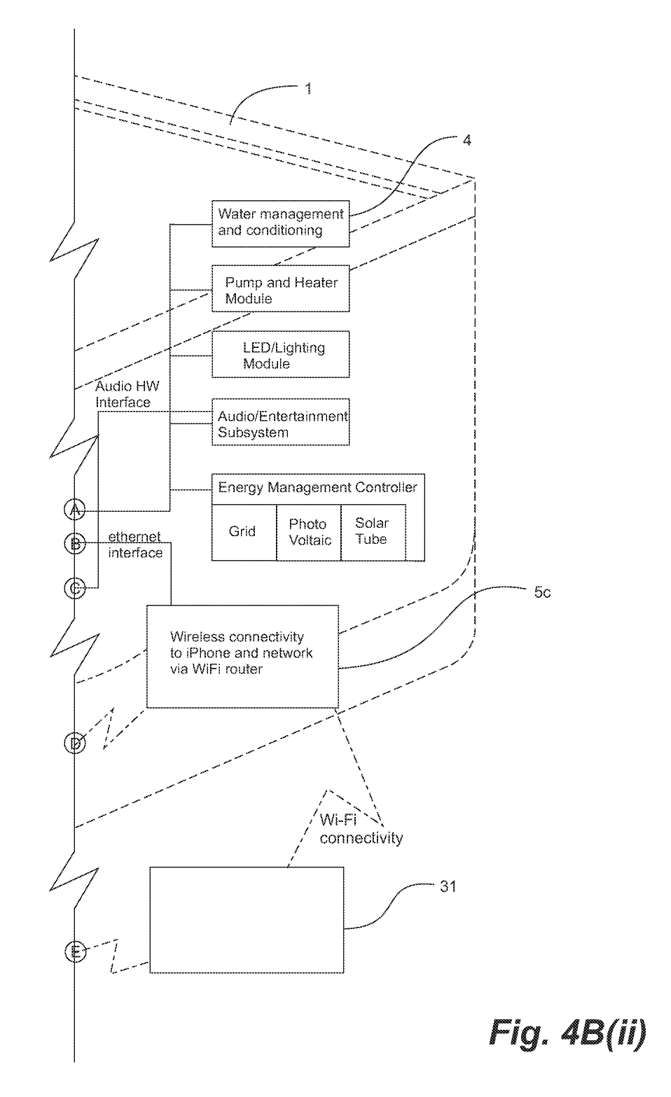

As shown in FIG. 2A, another embodiment of a wireless interface can comprise a BLUETOOTH receiver including a microcontroller 5b and a Wi-Fi router 5c. The BLUETOOTH signals are decoded by the BLUETOOTH microcontroller 5b. Wireless routers 5c are known and control signals from the remote wireless device 6 are transmitted through Wi-Fi protocols and are decoded by the Wi-Fi router 5c into serial data for communication with the wired interface 3. In one embodiment, the microcontroller 5b decoding the BLUETOOTH signals is a BLUETOOTH music receiver manufactured by Belkin, Model #F8Z492ttP. FIG. 5 illustrates one form of an integrated circuit (IC) arrangement of the BLUETOOTH microcontroller 5b. The IC comprises an antenna 8, a chip 9 supporting multimedia streaming, a crystal 10, a power input 11 and a stereo output 12 suitable for transmission to an audio system or an entertainment module of the spa. BLUETOOTH is a short range protocol which operates in the unlicensed 2.4 GHz spectrum, is inexpensive, and low powered.

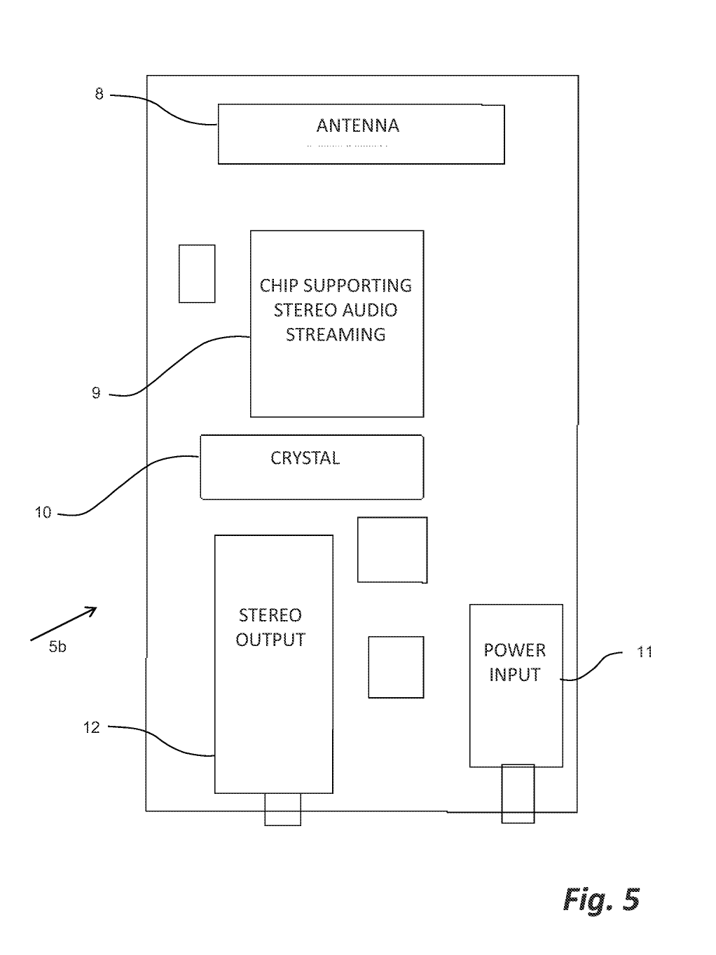

If the local control interface 7 is not compatible with the wired interface 3, such as if the local control interface 7 and the wired interface 3 are manufactured by different manufacturers, the wired interface 3 can be interfaced to the local control interface 7 through a protocol converter interface 13 (FIGS. 1 and 2) commonly referred to as a Top Side Control Protocol Converter Interface. FIG. 6 illustrates details of a circuit board assembly of one such protocol converter interface 13. The protocol converter interface 13 comprises a general purpose input/output port 14, a chip 15, a crystal 16, serial ports 17, a test port 18 such as a JTAG (Joint Test Action Port), a memory 19, data links 20 such as a SPI (Serial Peripheral Interface bus), a battery backup 21 and power input 22. The protocol converter interface 13 provides for the following functionalities: can accept TSC on/off signals typically Vcc/Ground, I2C serial, SPI serial, RS232 serial and or/TTL level serial, provide Vcc and Ground power, is programmable and is a low cost integrated micro-controller. The protocol converter interface 13 is remotely programmable.

FIGS. 7A and 7B illustrate various embodiments of implementing the wired interface 3. The wired interface 3 can also be referred to as a bottom side controller.

One implementation of the wired interface 3 is illustrated in a circuit board assembly 100A of FIG. 7A. The components or functionalities of the circuit board assembly 100A of the wired interface 3 comprise: I/O (inputs and outputs) 25 that interface to the electric control interface 4a that provides for heater activation, multiple pump activation and control; interface to entertainment sub systems such as audio systems, lighting/(LED) systems; water control and monitoring; flow control; energy management subsystems such as solar augmentation both photo voltaic and solar tube heating and other functions as required. The circuit board assembly 100A further comprises an integrated ethernet interface 26 to communicate to internet devices such as routers and switches and supports TCP/IP, telnet and FTP protocols to allow for communication with browsers and networked devices including the Wi-Fi router 5c and BLUETOOTH microcontroller 5b. A USB port 27 allows local in field upload/download of program updates or current software status and factory loading of software, and through connection to a wide area network can be remotely interrogated and updated with regards to current software status and/or to add new application features. The circuit board assembly 100A has multiple serial ports 28 to connect to multiple devices or modules 4 and can have optional controller-area network (CAN) bus controller 29 and ports to connect to more complex wired networks.

Another implementation of the wired interface 3 is illustrated in a circuit board assembly 100B of FIG. 7B. In this implementation of the wired interface 3, the processor 15 located at the wired interface 3 can decode the communication signal containing control data or BLUETOOTH data into control signals and audio signals suitable for module operation including an entertainment system. In one implementation, the processor 15 supports an operating system such as a Windows CE (Trademark of Microsoft Corporation) environment or a Linux environment (Trademark of Linux Mark Institute) and implements Wi-Fi and BLUETOOTH software or drivers for decoding the control signals transmitted using Wi-Fi. The components or functionalities of the circuit board assembly of the wired interface 3 comprise: I/O (inputs and outputs) 25, serial ports 28, a USB port 27 and a CAN bus controller 29.

The wired interface 3 can also have a security module to verify the commands are legitimate so as to confirm the control signals being received and processed are from a remote wireless device authorized by the user for controlling the spa.

The wireless device 6 can be used to control the spa 2 remotely by sending control signals to the control system 2. At a high level, these commands are received by the wireless interface 5 which is in communication with the wired interface 3. The wired interface 3 controls the various modules 4 of the spa 1 in response to the data contained in the Wi-Fi control signals through the electric board interface 4a. The Wi-Fi control signals are received by the wireless interface 5 and decoded at the wireless interface 5 or the wired interface 3. Control signals can also be keyed in by the user using the local control interface 7 located at the spa. The control signals from the local control interface 7 are either received directly by the wired interface 3 or are received by the wired interface 3 through the protocol converter interface 13.

In more detail, the control system 2 comprises microcircuits such as the wired interface 3, the wireless interface 5 and the protocol converter interface 13 that integrate currently existing local control interfaces 7 and wireless technologies. The local control interface 7 connects to the protocol converter interface 13 via a wired connection, which can provide on/off signals, I2C, SPI, RS232 or other serial signals. The protocol converter interface 13 interprets the various vendor specific actions for export as serial commands to the wired interface 3. The protocol converter interface 13 and the wired interface 3 both provide bi-directional control to their respective system components, i.e. the protocol converter interface 13 can send data parameter messages to the local control interface 7 for local display or alarm.

If control signals are input by a user using the local control interface 7, the wired interface 3 receives and sends commands and data messages to and from the protocol converter interface 13 via a serial port 28. If the control signals are input by a user using the remote wireless device 6, the wired interface 3 communicates with the wireless interface such as via the Ethernet interface 26.

The wired interface 3 is the primary spa controller, in addition to controlling and monitoring all spa functions, the wired interface 3 can send highly articulate and detailed commands via the Ethernet port to the Wi-Fi router 5c which in-turn communicates with Wi-Fi compatible wireless devices 6 such as smartphones and other computers. The remote wireless device 6 can be a laptop or a Personal Digital Assistant PDA or a Smartphone or a Wi-Fi mobile platform such as an iPod Touch™. Examples of Smartphones include iPhone™—Apple or Blackberry™—Research In Motion or phones based on the Android™ and Symbian™ operating systems.

The independent BLUETOOTH microcontroller 5b allows for BLUETOOTH connectivity including the receiving of streamed stereo audio data from the wireless device 6. The wireless device 6 may be Apple devices such as an iPhone™ and iPod Touch™, which do not generally permit transmission of audio data directly from the wireless device 6 where they can be subject to licensing restrictions.

Due to the nature of the architecture of the control system 2 numerous applications can be developed for the remote wireless device 6 such as the iPhone™ or other smartphones and for personal computers. These applications are made available or anticipated to be available via the World Wide Web (www) by the Applicant or third party developers thus enhancing functionality and minimizing obsolescence.

The control signals from the remote wireless device 6 are typically transferred to the control system 2 using Wi-Fi protocols. Considering licensing requirements, audio data, video data and still image data or multimedia data or interactive data can also be transmitted to the control system 2 using Wi-Fi protocols in addition to the control signals. Conveniently, audio data is streamed to the control system 2 from the remote wireless device 6 using BLUETOOTH protocols. Some or all of the control data could be implemented through the BLUETOOTH interface.

The audio data can be streamed to the entertainment module of the spa through the wired interface 3 or the BLUETOOTH controller 5b can be directly connected to the entertainment module of the spa.

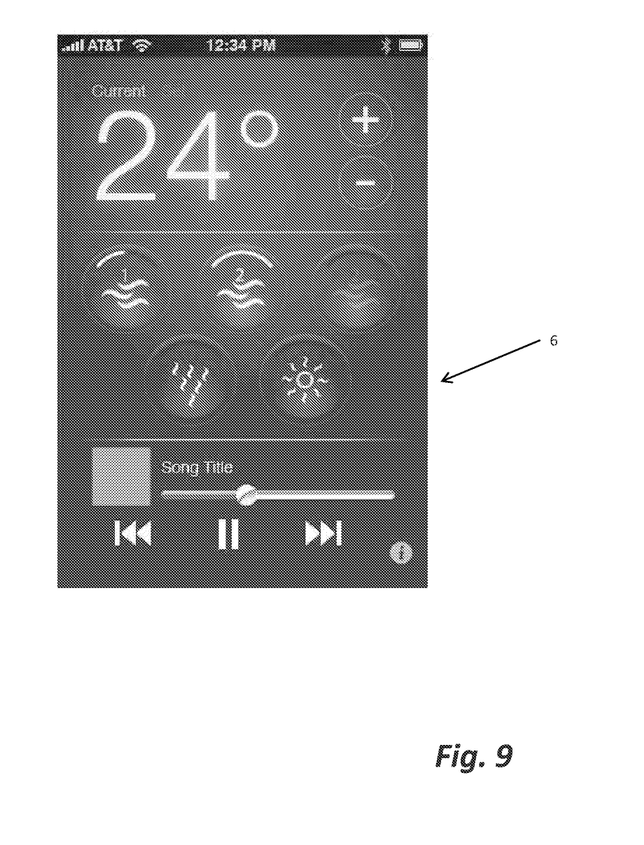

With reference to FIG. 9, status of various parameters of the spa modules 4 being controlled by the control system 2 can be displayed on the wireless device 6. For example, the current water temperature or state of pumps (on or off) or state of lights (on or off) or controls of the entertainment system (play/pause/stop/back) can be displayed on the display of the wireless remote device 6. It can be seen from the display illustrated in FIG. 9 that the current temperature of water is 24° C. and it can be changed by using the + and − buttons thereon. The display of FIG. 9 also shows the status of a particular song being played at the spa.

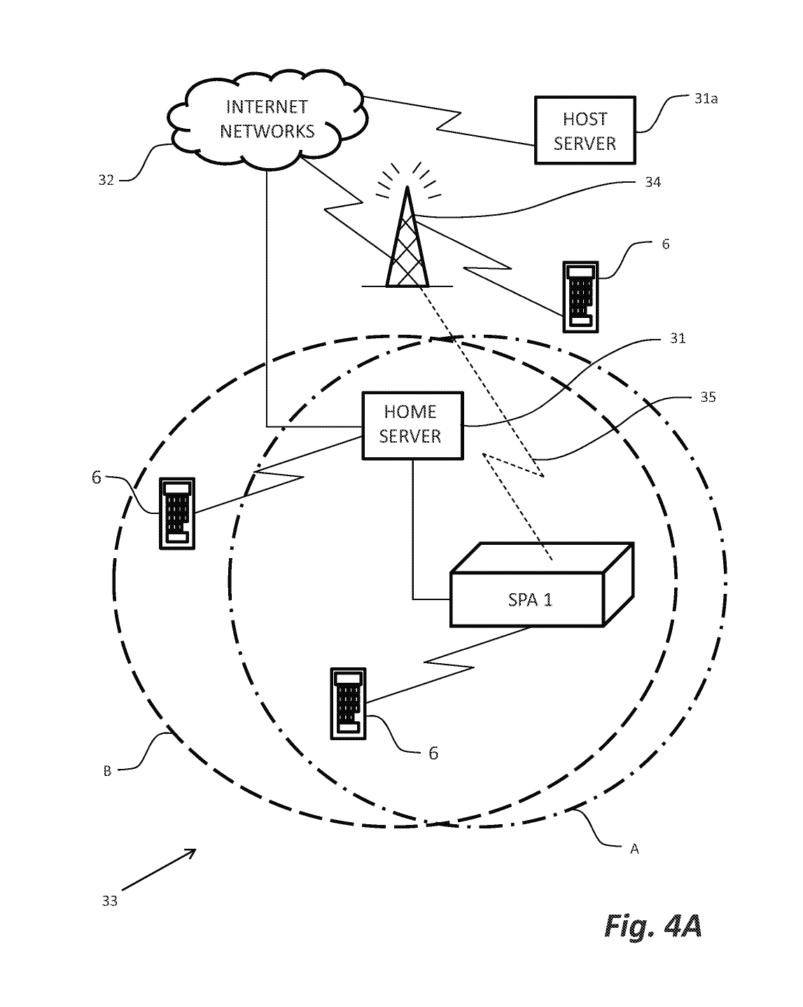

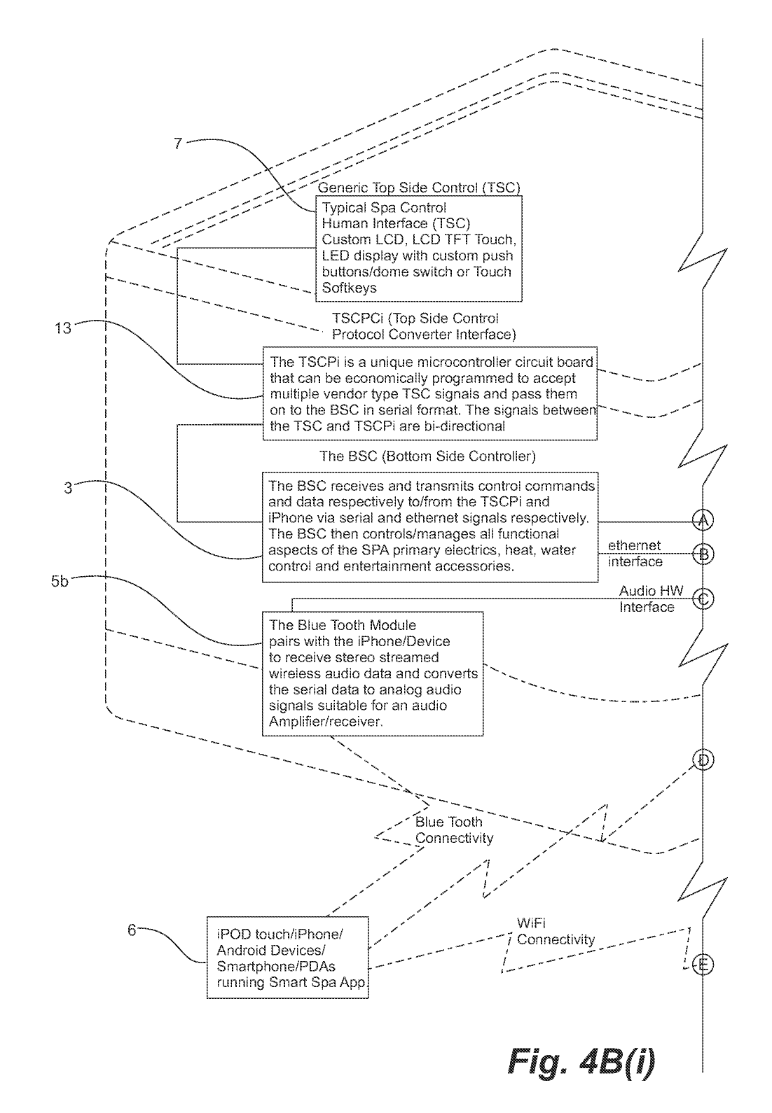

With reference to FIGS. 4A and 4B, a communication network 33 can be created wherein the spa 1 can communicate with local and/or remote servers. The spa 1 is connected to a local server 31. The local server 31 can be a home server 31. The home server 31 communicates with a remote server 31a through wired and/or wireless Internet networks 32 such as the world wide web. The remote or host server 31a can be a server hosted by the spa manufacturer or by the spa service company. The spa is identified by the remote server 31a and the local server 31 by a unique identifier such as an IP address. If the wireless device 6 is in the proximity of the spa 1 (refer to circle marked A), the wireless device 6 communicates with the spa 1 directly. If the wireless device 6 is not in the proximity of the spa 1 but is in the proximity of the home server 31 (refer to circle marked B), the wireless device 6 communicates with the spa 1 through the home server 31. If the wireless device 6 is not in the proximity of the home server 31, the wireless device communicates with the spa 1 through Internet networks 32. The home server can communicate with the host server 31 through the internet networks 32. Control signals are communicated to the spa 1 through the communication network 33. Communication regarding performance parameters of the spa modules 4 in the form of alerts or status updates are also communicated to the remote wireless device 6 through the communication network 33.

In another embodiment shown in FIGS. 4A and 2B, the spa 1 can be fit with a cellular modem 5d. If the home server 31 or the internet network 32 is unavailable, then the remote wireless device 6 can communication with the spa through cell tower 34 and cellular modem 5d. Spa 1 can also communicate with the host server 31a, shown in dotted lines, between the cell tower 34 and cellular modem 5d.

The communications circuitry, used by the control system 2 to communicate with the local and/or remote servers may include, for example, a modem such as a telephone modem, cable modem, ISDN modem, DSL modem, or any other suitable wired communications circuitry for connecting to the telephone network, or the Internet, or other suitable communications network through a wired path. The communications circuitry used by the Wi-Fi router 5b to communicate with the home server 31 may include any suitable RF transmitter circuitry or transmitter and receiver circuitry that is capable of communicating over short distances.

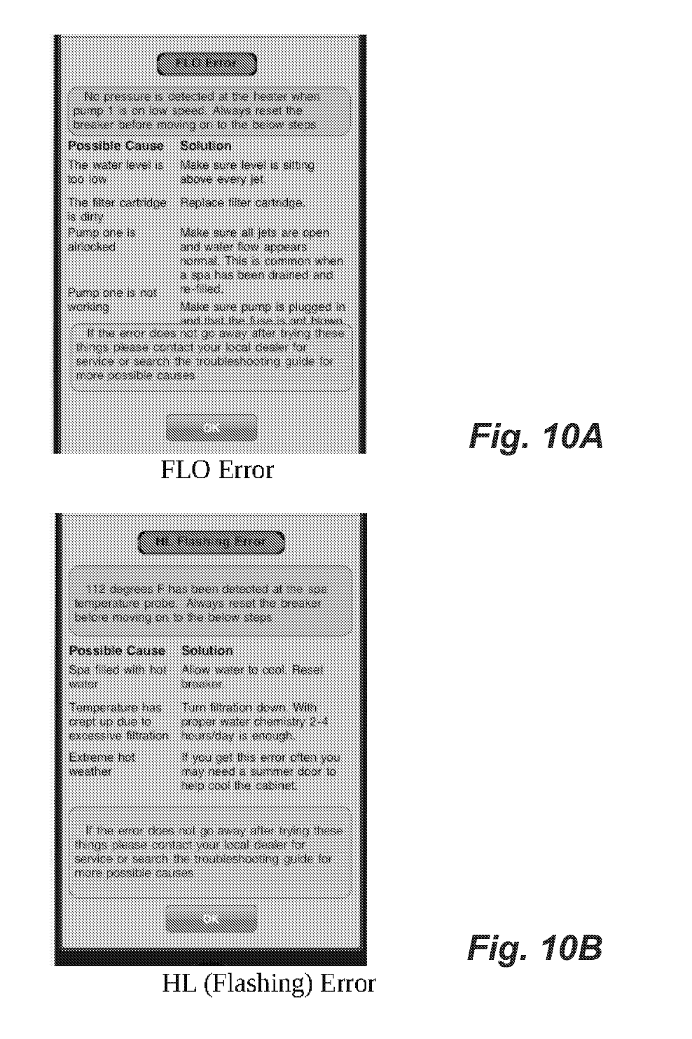

Logs can be created at the manufacturer's end on the basis of behavioral pattern of the various modules 4. For example, a log of power consumed by the spa 1 over a set period of time can be maintained to determine whether any component of the spa 1 requires replacement or repair if the power consumed exceeds a certain threshold. Alerts to the spa owner based on these logs can be sent by the manufacturer using the communication network 33. The alerts can be sent to the wireless remote device 6 or to a device connected to the home server 31 of the spa owner. Alerts can be in the form of a popup in an application on the wireless device 6 or SMS (Short Messaging Service) or an email or a voice message or any other suitable communications technique. Alerts can appear on the wireless remote device 6 of the user, for example, the spa owner may be notified that that the temperature has dropped below a threshold (FIG. 10B) or one of the pumps is blocked (FIG. 10A).

The control system 2 provides several features which increase the functionality of existing spas. The wired interface 3 can provide industry standard connectivity to multi-vendor spa control local control interfaces 7 or panels. There is increased safety due to an ability to communicate wirelessly to a user to notify of impending or current fault conditions. User interaction can be performed, even remotely, using an intuitive and familiar smart phone application on the remote wireless device 6 for controlling the spa 1. Parameters, applications and status available on the wired interface 3 can be remotely diagnosed and remotely upgraded through the local control interface 7, obviating the need for a field service technician to replace or upgrade system software or firmware. Wireless communications can be implemented using conventional Wi-Fi 802.11b/g/n and BLUETOOTH protocols. The remote device 6 and the spa 1 can now access the internet via Wi-Fi through an internet browser, telnet or FTP. One can provide access to a dedicated host server (e.g. host server 31a) to provide worldwide spa access via Short Messaging Service (SMS) messaging, internet browser or dedicated spa application. Obsolescence is avoided by providing an open developer platform for unlimited applications. Media is now available at the spa for enhanced entertainment applications including use of media within various licensing schemes. Further, a storage system is available for recording and archiving all parameters and storage of media data for future retrieval and playback, if applicable.

The control system 2 overcomes the limitations of current spa controllers that require the user to be physically adjacent to the spa to set operation parameters and or determine if a maintenance or fault condition has occurred. The control system 2 advances the state of spa controllers by providing an open architecture multi application interface or environment that is capable of communicating and interacting with various commonly available wireless devices and the internet. Simply, the wireless device 6 is in communication with the processor 3 through a wireless interface 5a for management of the spa.

The wireless device 6 is in communication with the control system 2 through Wi-Fi and BLUETOOTH communication interfaces. Each wireless protocol has its strengths and limitations. Wi-Fi has the advantage of industry standard and bi-directional data communications which can be manipulated for receiving and transmitting data such as control setpoints and measured data. BLUETOOTH has an advantage in the short range transmission, particularly of media data which, in some instances, also enable extension of the media experience while remaining compliant with digital rights management prevalent with some digital media providers. Other wireless devices, as a platform for less-restricted media, including MP3 music formats, could also use the Wi-Fi communication protocols.

The processor 15 can be accessible to the user through a GUI form of a local control interface using the remote wireless device 6. Accordingly, there need not be an intermediate, or local interface.

The control system 2 uses an open and available license free or low fee operating system that provides an application programming environment that is common and well understood by application programmers to expeditiously, and at reduced risk, develop control applications, develop communication applications either wirelessly or wired to devices for remote messaging and control, develop multimedia entertainment applications for audio, pictures and moving video, develop lighting and visual accessories submersed in the water media of the spa and external to the water media to enhance the spa experience, develop to remotely accept new or upgraded or modified applications remotely via the internet via the wireless communication protocol, develop energy algorithm applications to effectively use electricity from solar photo panels and/or solar heated water or glycol fluid to offset electrical consumption from the electrical grid, develop application programs that monitor and optimize energy consumption and document and report same, develop multi media and control data filing and archiving application for future recall or reporting, and support some or all the following data and control interconnections: I2C, SPI, RS232, RS485, CAN bus and Device NET, digital inputs and outputs optically isolated or otherwise, analog inputs, analog outputs, USB, SD Flash, TFT display control, touch screen control, audio codec/s, audio sound, DC input voltage, DC output voltage, Wi-Fi 802.11b/g/n, BLUETOOTH, GSM and CDMA cell phone modem and GPS signals.

The embodiments of the invention for which an exclusive property or privilege is claimed are defined as follows:

1. A wireless control system for controlling various modules of a spa, the wireless control system comprising:
a wireless interface for receiving a combination of communication signals and BLUETOOTH signals transmitted from a remote wireless device, the communication signals contain control data for controlling the various modules of the spa and the BLUETOOTH signals contain media data for use at the spa; and
a wired interface in communication with the wireless interface and connected to the various modules of the spa, the wired interface controlling the various modules of the spa in response to the control data contained in the communication signal and communicated to the wired interface by the wireless interface.

2. The control system of claim 1 wherein the wireless interface further comprises a BLUETOOTH microcontroller for receiving and decoding the BLUETOOTH signals and a Wi-Fi router for receiving and decoding the communication signals, the communication signals being transmitted using Wi-Fi protocols.

3. The control system of claim 2 wherein the wireless interface further comprises a cellular modem for receiving and decoding the communication signals, the communication signals being transmitted using Code Division Multiple Access (CDMA) or Global System for Mobile Communications (GSM) protocols.

4. The wireless control system of claim 3 wherein the spa is in communication with a host server through the cellular modem.

5. The control system of claim 1 wherein the wireless interface comprises drivers for receiving and decoding the communication signals and the BLUETOOTH signals, the drivers being embedded in an operating system.

6. The control system of claim 5 wherein the operating system is a Windows CE™ platform or a LINUX™ platform.

7. The control system of claim 1 wherein the wired interface further comprises an electric control interface and the wired interface is connected to the various modules of the spa through the electric control interface.

8. The wireless control system of claim 1 wherein the communication signals are transmitted to the wireless interface directly or through a communication network.

9. The wireless control system of claim 1 wherein the spa is in communication with a remote server through a home server and an internet network.

10. The control system of claim 1 wherein the control data further comprises audio, video, image, or multimedia data.

11. The control system of claim 1 wherein the remote wireless device comprises a Personal Computer (PC) or a Personal Digital Assistant (PDA).

12. The wireless control system of claim 1 further comprising a local control interface located at the spa and in communication with the wired interface.

13. The wireless control system of claim 12 wherein the local control interface is in communication with the wired interface through a protocol converter interface.

14. The wireless control system of claim 12 wherein control signals are input by a user using the local control interface, the control signals being decoded by the wired interface for controlling the various modules of the spa.

15. The wireless control system of claim 12 wherein the wired interface can be re-programmed by the user through the local control interface.

16. The wireless control system of claim 1 wherein the various modules of the spa being controlled by the control system are selected from a group consisting of a pump, a heater, lighting, an entertainment system and an energy management module.

17. The wireless control system of claim 1 wherein performance parameters of the various modules of the spa are displayed on the remote wireless device.

18. The wireless control system of claim 1 wherein the remote wireless device is a smartphone and performance parameters of the various modules of the spa are displayed on the smartphone through an application installed on the smartphone.

19. The wireless control system of claim 1 wherein the media data from the remote wireless device is streamed to an entertainment module.

20. The wireless control system of claim 1 wherein the media data further comprises some or all of the control data.

21. The control system of claim 3 wherein performance parameters of the various modules of the spa are communicated to the remote wireless device through the cellular modem.

22. The control system of claim 8 wherein performance parameters of the various modules of the spa are communicated to the remote wireless device through the communication network.
